(19) United States
(12) Patent Application Publication
(10) Pub. No.: US 2009/0207692 A1
(43) Pub. Date: Aug. 20, 2009

(54) STEADY BEARING ASSEMBLY AND METHOD FOR MIXER IMPELLER SHAFTS

(75) Inventor: Richard Bourbonnais, Rochester, NY (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corporation, Charlotte, North Carolina

(21) Appl. No.: 12/031,298

(22) Filed: Feb. 14, 2008

(51) Int. Cl. B01F 7/00; B21D 53/10

(52) U.S. Cl. 366/261; 29/898.07

(57) ABSTRACT

A steady bearing for supporting an end of an impeller shaft with respect to a mixer vessel wall, includes a downwardly projecting cylindrical hollow sleeve mounted to the end of the shaft and projecting away from the end of the shaft, an upwardly projecting bearing holder mounted to the bottom of the vessel wall and projecting upwardly inside part of the hollow portion of the sleeve, and a roller bearing assembly mounted in between the bearing holder and the sleeve.

### FIELD OF THE INVENTION

The invention pertains generally to the field of mixing assemblies and related bearings. More particularly, the invention relates to steady bearings used to provide support to a mixer impeller shaft with respect to a mixer vessel.

### BACKGROUND OF THE INVENTION

Industrial mixers are in wide use. In general, many of these mixers include a vessel that contains a material to be mixed or agitated. Projecting into the vessel is a shaft having radially extending impellers or paddles. Sometimes the shaft is supported from the top of the vessel and driven by a motor located at the top of the vessel. The shaft extends downwardly and in some instances simply has a free hanging lower end spaced apart from the bottom of the vessel. In the case of long shafts and shafts that extend all the way down to very near the bottom of the vessel, a so-called “steady bearing” is sometimes used. The steady bearing is an assembly that connects the rotating lower tip of the shaft to the bottom of the mixer vessel. Steady bearings are known that use an intermediate sliding friction bushing.

One example of a steady bearing for the bottom tip of a mixer impeller shaft is a type of bearing that uses a sleeve-type bushing that has a frictional rotational sliding contact interposed between a rotating part connected to the bottom end of the shaft and a stationary part connected to the bottom of the vessel.

A disadvantage of the sliding friction bushing type steady bearings can be that they often do not perform well when dry running. In some applications, it is desirable to have dry running performance so that the bearing can be operated while the vessel is being emptied. Also, these bushings may not perform well when exposed to cleaning solutions while mixing. Further, the materials that are used in the case of bushing type steady bearings may not be suitable for certain applications due to material contact, metallic wear, and/or inability to perform at certain temperatures.

Accordingly, there is a need in the art for an improved steady bearing for use to support the free end of a mixer impeller shaft with respect to a vessel wall.

### SUMMARY OF THE INVENTION

Some embodiments of the present invention provide a steady bearing that is used to support the free end of a mixer impeller shaft with respect to a vessel wall.

An embodiment of the present invention is a steady bearing for supporting an end of an impeller shaft with respect to a mixer vessel wall which includes a downwardly projecting cylindrical hollow sleeve mounted to the end of the shaft and projecting away from the end of the shaft, an upwardly projecting bearing holder mounted to the bottom of the vessel wall and projecting upwardly inside part of the hollow portion of the sleeve, and a roller bearing assembly mounted in between the bearing holder and the sleeve.

Another embodiment discloses a steady bearing for supporting an end of an impeller shaft with respect to a mixer vessel wall, comprising a downwardly projecting cylindrical hollow outer bearing engaging means mounted to the end of the shaft and projecting away from the end of the shaft, an upwardly projecting inner bearing engaging means mounted to the bottom of the vessel wall and projecting upwardly inside part of the hollow portion of the outer bearing engaging means and a roller bearing assembly mounted in between the inner bearing engaging means and the outer bearing engaging means.

Yet another embodiment provides a method of installing a steady bearing for supporting the end of an impeller shaft with respect to a mixer vessel wall, comprising mounting a pedestal to the vessel wall, with the pedestal having a bearing mounting portion having an aperture therethrough that is spaced apart from the vessel wall, inserting a central bearing holder through the aperture to project away from the vessel wall, mounting a downwardly projecting cylindrical hollow sleeve to the end of the shaft projecting away from the end of the shaft and towards the vessel wall, installing a roller bearing assembly onto the upwardly projecting bearing holder, and inserting the upwardly projecting bearing holder and the roller bearing assembly inside the cylindrical hollow sleeve, wherein each of the steps can be performed in any order.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a cross-sectional view of a steady bearing according to a first preferred embodiment of the invention.

FIG. 2 is a cross-sectional view of a steady bearing according to a second preferred embodiment.

FIG. 3 is a top cross-sectional view of the steady bearing of FIG. 2 taken through lines 3-3.

### DETAILED DESCRIPTION

Some embodiments of the present invention provide a steady bearing that is used to support the free end of a mixer impeller shaft with respect to a vessel wall. Some preferred embodiments of the invention will now be described with respect to the drawing figures in which like reference numerals are referred to like parts throughout.

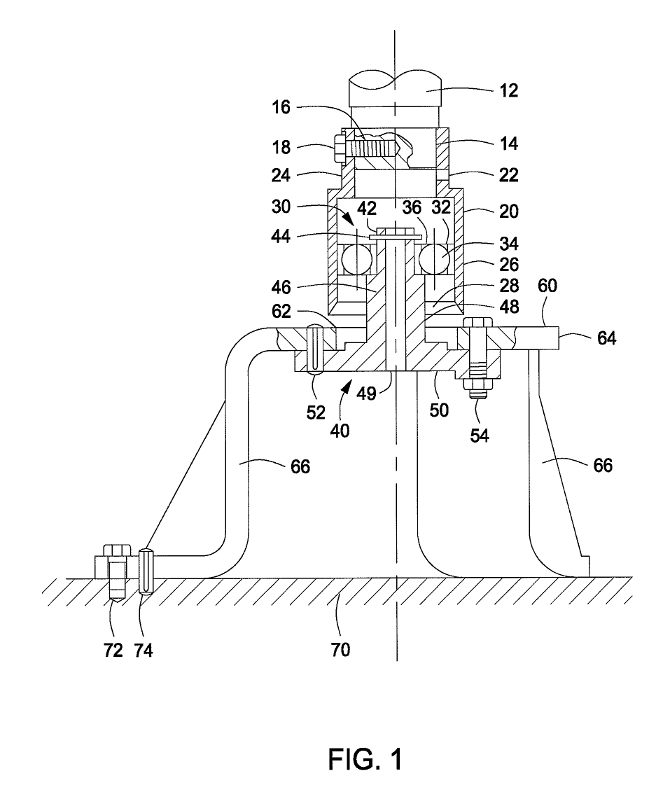

Turning first to FIG. 1, a first embodiment is shown. The lower end of a shaft 12 is typically supported from above and essentially hangs into a mixer vessel. The shaft 12 is typically rotated by a motor (not shown) outside the mixer vessel, and typically has radially extending impellers or paddles (not shown) extending outwardly therefrom.

In the example given, the lower end of the shaft 12 has a reduced diameter portion 14 that has a threaded mounting hole 16 projecting therein. A bolt 18 mounts a bearing sleeve 20 to the lower end of the shaft. The sleeve 20 also has a tapered lower end portion 28, the significance of which is described further below. The bearing sleeve 20 has one or more vent holes 22 projecting therein below the bottom end of the shaft 12 which are discussed in more detail below. The sleeve 20, in this example, has a reduced diameter portion 24 which has an inner diameter sized to go over the end diameter of the reduced diameter portion of the shaft 14. Of course, the shaft may have a constant diameter across its lower portions 12 and 14, and the portion 24 of the sleeve 20 rather than being a reduced diameter portion as in this example may have a larger diameter, based on whatever diameter is needed to mount securely to the bottom end of the shaft 12.

The bearing sleeve 20 also has, in this example, an increased diameter portion 24. The increased diameter portion 24 has an inner diameter sized for sliding contact with a rotating element bearing 30. In this example, the bearing assembly 30 has an outer race 32, a plurality of balls 34, and an inner race 36. A cage (not shown) may be interposed between the races to maintain the balls 34 and evenly spaced circumferential alignment.

The inner race 36 sits upon an upwardly projecting bearing holder element 40. The bearing holder element 40 has a top portion 42 having a diameter sized to accept the inner diameter of the inner race 36. A clip such as a C-shaped ring 44 can be provided to trap the inner race 36 between the clip 44 and a shoulder 46 on the bearing holder 40. Although a snap ring 44 is shown, in some instances, a threaded knot may be tightened down around the top section 42. The bearing holder 40 has a larger diameter post 48 projecting upward from a bottom plate 50, also a part of the bearing holder 40. The bearing holder 40 also has a central longitudinal bore 49 extending all the way therethrough from the bottom to the top. The plate 50 is mounted to a pedestal 60 by virtue of one or more pins 52 and attachment bolts 54. The pin 52 is press fit into a hole in the lower portion 50, and has a sliding fit with an accepting hole in the pedestal 60. The pedestal 60 has an aperture 62 which is sized to permit at least the portions 48 and 42 of the bearing holder 40 to extend upward therethrough. The aperture 62 may also be sized to permit the sleeve 20 to be extended upward therethrough during installation if desired.

The pedestal 60 has a generally horizontal mounting portion 64 and a plurality of legs 66, in this example three legs 66 form a tripod. The legs 66 are fastened to the bottom of the mixing vessel 70 by respective pins 72 and bolts 74.

It will be appreciated that in this assembled configuration the sleeve 20 rotates together with the shaft, and the bearing assembly 30 provides radial restriction of the position of the sleeve 20, due to its interaction with the bearing holder 40 which is held fixed during operation. The outer race 32 has a sliding contact with the inner surface of the sleeve 20, so that axial up and down movement of the sleeve 20 with respect to the bearing holder 40 is accommodated by sliding. This is advantageous because in the case of temperature change the shaft 12 may elongate or contract, causing axial up and down movement of the sleeve 20. Further, the flexing of the shaft and the intermediate position of the shaft may also cause some degree of axial movement of the sleeve 20. An advantage of the arrangement shown in the figures is the ability to accommodate this axial movement through sliding, without putting any axial load on the bearing. That is, the bearing has only radial loads and is not subjected to any significant axial thrust load.

In the illustrated embodiments, the bearing shown is a roller type bearing 30. More specifically, in the example given, the roller bearing 30 is a ball type bearing utilizing balls 34. A roller type ball bearing is preferred in the embodiments of this invention, but in other embodiments it can be any type of roller bearing that uses a rolling contact as opposed to the sliding bushing.

The roller bearing 30 may be made from any of a wide variety of suitable materials. In some examples, the roller bearing 30 may be made of all steel. Steel has the advantages of operating to high temperature. However, in some applications, it is desirable to avoid the metallic particles that occur due to wear, or otherwise avoid the use of metal bearings. Other materials that can be used for the bearing include glass-filled Teflon, or alternatively PEEK. However, a disadvantage with some of these and similar non-metallic materials is that they may not be suitable for high temperature operation, such as for example operation in some applications greater than 400 degrees Fahrenheit. Therefore, in some embodiments the bearing races and/or roller elements are made from a ceramic material such as ceramic cured silicon nitride. In one preferred embodiment, the races are 440C nickel coated material, the balls are ceramic cured silicon nitride, and the core is glass-filled Teflon.

A benefit of using the pins 52 in combination with the bolts 54 is that the pins 52 absorb the radial loads and also provide accurate positioning without subjecting the bolts 54 to significant radial loads which may be undesirable or cause misalignment, or be loosened by vibration.

One example of a preferred method of installing the arrangement shown in FIG. 1 will now be described. In a first step, the shaft 12 is simply being suspended in the position shown from above, and the pedestal 60 remains mounted to the vessel wall 70. At this initial stage, neither the sleeve 20, the bearing 30 nor the bearing holder 40 are present. If the aperture 62 is sufficiently large as to allow the sleeve 20 to pass through, then the sleeve 20, bearing 30, and bearing holder 50 can be assembled substantially in the configuration shown, and slid under the horizontal portion 64 of the pedestal 60 and pushed upwardly through the aperture 62 into the final operating position. At this point, the bolt 18 can be affixed and the bolt 54 can be affixed with either one being affixed first. In situations where the outer diameter of the sleeve 20 is greater than the diameter of the aperture 62, the shaft 12 can often be swung somewhat out of the way of the pedestal 60 if needed, and the sleeve 20 can be first mounted to the end of the shaft 12 using the bolt 18. Then, the bearing holder 40 can be slid under the pedestal 60, and its upwardly projecting shaft 42 and 48 can be projected through the aperture 62, and the bearing holder 40 then mounted via the bolt 54 into the position shown.

In either of the above installations, the taper 28 facilitates the sliding of the bearing 30 into the inner diameter of the sleeve 20. This can be particularly advantageous in the case of ceramic or PEEK bearings, which can tend to be more brittle than metallic bearings.

The combination of the vent 22 and the bore 49 provide for draining of material that can accumulate inside of the sleeve 20. That is, as the vessel is emptied, the vent 22 allows an influx of air and the bore 49 allows drainage of material that would otherwise possibly be trapped inside the sleeve 20. Further, drainage will occur through the gaps or spaces between the roller elements 34 of the roller bearing 30.

An advantage of this assembly method is that the pedestal 60 in these embodiments does not need to be removed from the bottom of the vessel 70. Of course, in other embodiments, depending on the relative dimensions, it may be necessary to remove the pedestal 60. Moreover, although an elevated pedestal 60 is shown, embodiments are possible where the bearing holder 40 is simply directly bolted to the bottom of the vessel 70 itself, and projects upward to support roller bearing 30 inside an outer bearing sleeve 20 otherwise in the manner as shown.

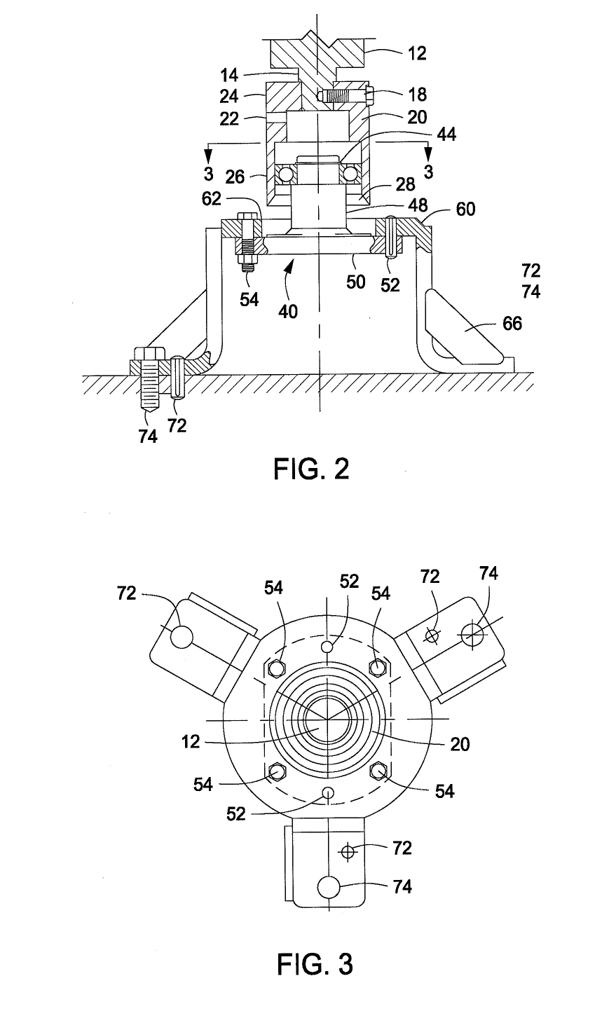

FIGS. 2 and 3 depict a second embodiment with some design variations. Like reference numerals refer to corresponding parts with the variations in some parts.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A steady bearing for supporting an end of an impeller shaft with respect to a mixer vessel wall, comprising:
a downwardly projecting cylindrical hollow sleeve mounted to the end of the shaft and projecting away from the end of the shaft;
an upwardly projecting bearing holder mounted to the bottom of the vessel wall and projecting upwardly inside part of the hollow portion of the sleeve; and
a roller bearing assembly mounted in between the bearing holder and the sleeve.

2. The bearing according to claim 1, wherein the roller bearing is a ball bearing assembly with an outer race and an inner race.

3. The bearing according to claim 2, wherein the inner race of the bearing is axially fixed with respect to the bearing holder, and the outer race of the bearing is in slidable contact with the inner surface of the sleeve.

4. The bearing according to claim 1, wherein the sleeve has a vent port extending therethrough.

5. The bearing according to claim 1, wherein the bearing assembly is at least partially manufactured from a ceramic material.

6. The bearing according to claim 1, wherein the races are manufactured from nickel-coated 440C material.

7. The bearing according to claim 2, wherein the balls are manufactured from ceramic cured silicon nitride.

8. The bearing according to claim 1, wherein the bearing holder is mounted to the vessel wall by a pedestal that spaces the bearing holder away from the vessel wall.

9. The bearing according to claim 1, wherein the pedestal has a central aperture and part of the bearing holder projects through the pedestal central aperture.

10. The bearing according to claim 1, wherein the bearing sleeve has a tapered diameter at its open end.

11. A steady bearing for supporting an end of an impeller shaft with respect to a mixer vessel wall, comprising:
a downwardly projecting cylindrical hollow outer bearing engaging means mounted to the end of the shaft and projecting away from the end of the shaft;
an upwardly projecting inner bearing engaging means mounted to the bottom of the vessel wall and projecting upwardly inside part of the hollow portion of the outer bearing engaging means; and
a roller bearing assembly mounted in between the inner bearing engaging means and the outer bearing engaging means.

12. The bearing according to claim 11, wherein the roller bearing is a ball bearing assembly with an outer race and an inner race.

13. The bearing according to claim 11, wherein the inner race of the bearing is axially fixed with respect to the inner bearing engaging means, and the outer race of the bearing is in slidable contact with the inner surface of the outer bearing engaging means.

14. The bearing according to claim 11, wherein the outer bearing engaging means has a vent port extending therethrough.

15. The bearing according to claim 11, wherein the bearing assembly is at least partially manufactured from a ceramic material.

16. The bearing according to claim 11, wherein the races are manufactured from nickel-coated 440C material.

17. The bearing according to claim 12, wherein the balls are manufactured from ceramic cured silicon nitride.

18. The bearing according to claim 11, wherein the inner bearing engaging means is mounted to the vessel wall by a pedestal that spaces the inner bearing engaging means away from the vessel wall.

19. The bearing according to claim 11, wherein the pedestal has a central aperture and part of the inner bearing engaging means projects through the pedestal central aperture.

20. The bearing according to claim 11, wherein the outer bearing engaging means has a tapered diameter at its open end.

21. A method of installing a steady bearing for supporting the end of an impeller shaft with respect to a mixer vessel wall, comprising:
mounting a pedestal to the vessel wall, with the pedestal having a bearing mounting portion having an aperture therethrough that is spaced apart from the vessel wall;
inserting a central bearing holder through the aperture to project away from the vessel wall;
mounting a downwardly projecting cylindrical hollow sleeve to the end of the shaft projecting away from the end of the shaft and towards the vessel wall;
installing a roller bearing assembly onto the upwardly projecting bearing holder; and
inserting the upwardly projecting bearing holder and the roller bearing assembly inside the cylindrical hollow sleeve,
wherein each of the steps can be performed in any order.
